(19) United States
(12) Patent Application Publication
(10) Pub. No.: US 2020/0239739 A1
(43) Pub. Date: Jul. 30, 2020

(54) SHEET ADHESIVE AND ADHESION METHOD THEREOF

(71) Applicant: XIAMEN ZL DIAMOND TECHNOLOGY CO., LTD., Xiamen, Fujian (CN)

(72) Inventors: Kerong RUAN, Xiamen, Fujian (CN); Biao HU, Xiamen, Fujian (CN)

(21) Appl. No.: 16/755,982

(22) PCT Filed: Jan. 2, 2019
(86) PCT No.: PCT/CN2019/070095

§ 371 Date: Apr. 14, 2020

(30) Foreign Application Priority Data
Jan. 2, 2018 (CN) 201810001878.5

(51) Int. Cl. C09J 7/21; C09J 7/26; C09J 5/04

(52) U.S. Cl. CPC C09J 7/21; C09J 2205/30; C09J 5/04; C09J 7/26

(57) ABSTRACT

The present invention relates to a sheet-shaped adhesive and an adhesion method thereof, wherein the sheet-shaped adhesive includes a sheet carrier, a colloid, and isolation films; the sheet carrier has a plurality of non-closed accommodation spaces densely distributed therein; the colloid is coated on the sheet carrier, permeates and fills all the accommodation spaces; and the isolation films seal and wrap the sheet carrier coated with the colloid, so as to solve the problem that the existing adhesive easily causes waste and easily forms air bubbles to cause poor adhesion.

### TECHNICAL FIELD

The present invention relates to an adhesive field, and specifically relates to a sheet adhesive and an adhesion method thereof.

### BACKGROUND ART

Adhesives are chemicals that adhere two things together, and the commonly used adhesives include one-component adhesives and two-component adhesives. The two-component adhesives such as epoxy resin adhesives, acrylate adhesives and the like have many advantages of high transparency, being perfect and flawless after the adhesive object is cured, being unnecessary to be heated, being able to be cured at a room temperature, being environmental and non-poisonous, high adhesion strength, good toughness, oil resistance, water resistance, etc., and the cured object has good insulation, compression resistance, low shrinkage and other electrical and physical characteristics, and is a commonly used adhesive.

The commonly used two-component adhesives (also called as AB adhesives) include raw adhesives and curing agents, the traditional use method is mixing two kinds of components in a certain proportion and using the mixture after stirring, and this adhesive has the following disadvantages: (1) after the two components are mixed, materials may be cured within a certain time, must be used within a limited time, and cannot be used after being cured, and this use method often causes waste, especially needs a work of long-term adhesion operations, so that it is very inconvenient; (2) it is necessary to stir sufficiently before use, but the manual stirring usually causes insufficient mixing of the two components and air bubbles generating in the material, thereby easily affecting the adhesion effect and causing problems of poor adhesion and the like; and (3) the manual mixing and two-component respectively extruding or dispensing methods all cannot fill the parts to be adhered better, especially narrow adhesion spaces and the like cannot be filled better, thereby easily forming cavities such as air bubbles and the like and causing insufficiency of effective adhesion strength.

### SUMMARY

The present invention aims at providing a sheet adhesive and an adhesion method thereof, so as to solve the problem that the existing adhesive easily causes waste and easily forms air bubbles to cause poor adhesion.

The specific solutions are as follows:

A sheet adhesive, including a sheet carrier, a colloid, and isolation films, wherein the sheet carrier has a plurality of non-closed accommodation spaces densely distributed therein; the colloid is coated on the sheet carrier, permeates and fills all the accommodation spaces; and the isolation films seal and wrap the sheet carrier coated with the colloid.

Further, the colloid is a one-component curing adhesive, and the one-component curing adhesive includes a light curing adhesive, a water vapor curing adhesive, an air curing adhesive, a heat curing adhesive, or a pressure sensitive curing adhesive.

Further, the sheet carrier includes a single-layer mesh cloth, a three-dimensional mesh cloth, a polymer sheet skeleton having micropores, a natural fiber textile sheet or a synthetic fiber textile sheet or a mixed fiber textile sheet constituted by fibers being interwoven with each other, or is constituted by several short fibers dispersed in the colloid to form having a carrier function.

The present invention also provides another sheet adhesive, which includes a first sheet carrier, a second sheet carrier, a first colloid, a second colloid and an isolation film, wherein the first sheet carrier and the second sheet carrier both have a plurality of non-closed accommodation spaces densely distributed therein; the first colloid is coated on the first sheet carrier, permeates and fills all the accommodation spaces, to constitute a first sheet adhesive single piece; the second colloid is coated on the second sheet carrier, permeates and fills all the accommodation spaces, to constitute a second sheet adhesive single piece; the isolation films seal and wrap the first sheet adhesive single piece and the second sheet adhesive single piece, respectively; the first colloid and the second colloid are one of a raw adhesive and a curing agent, respectively; and the first sheet adhesive single piece and the second sheet adhesive single piece form a two-component curing adhesive.

Further, the first sheet carrier and the second sheet carrier include a single-layer mesh cloth, a three-dimensional mesh cloth, a polymer sheet skeleton having micropores, a natural fiber textile sheet or a synthetic fiber textile sheet or a mixed fiber textile sheet constituted by fibers being interwoven with each other, or are constituted by several short fibers dispersed in the colloid to form having a carrier function.

Further, surfaces of the first sheet adhesive single piece and the second sheet adhesive single piece are formed with concave and convex structures that are matched with each other, respectively.

The present invention also provides an adhesion method of the first sheet adhesive, which includes the following steps:

S1. providing the above first sheet adhesive;

S2. removing the isolation films of the sheet adhesive, and placing the same on a surface to be adhered; and

S3. providing a curing condition, so as to make the sheet adhesive be cured.

The present invention also provides an adhesion method of the second sheet adhesive, which includes the following steps:

S1. providing the above second sheet adhesive which includes a first sheet adhesive single piece and a second sheet adhesive single piece;

S2. removing the isolation films of the first sheet adhesive single piece and the second sheet adhesive single piece, respectively, and placing the same on a surface to be adhered, respectively; and

S3. applying pressures to the first sheet adhesive single piece and the second sheet adhesive single piece to make the first colloid and the second colloid of the first sheet carrier and the second sheet carrier be permeated and mixed with each other, so as to make the sheet adhesive be cured.

A sheet adhesive and an adhesion method thereof provided in the present invention have the following advantages in comparison with the prior art: the sheet adhesive provided in the present invention coats the colloid on the sheet carrier, and performs sealing and wrapping, may be cut into a required shape (that is, size) according to requirements when using it, and is laminated on the required area after tearing the isolation film, so as to be cured. This method can take materials according to sizes of adhesion interfaces, thereby reducing waste of the adhesive and facilitating a work required for long-term adhesive operations. In addition, the two components are fully fitted according to a proportion of the adhesion interfaces. After the lamination, the raw adhesive and the curing agent are mixed uniformly, which can effectively ensure that the raw adhesive is fully cured and ensure the adhesion effect. In addition, at narrow adhesion interfaces, it is also convenient for sizing, thereby effectively avoiding the problem of incomplete adhesion.

### BRIEF DESCRIPTION OF THE DRAWINGS

FIG. 1 shows a diagram of a one-component sheet adhesive of Embodiment 1;

FIG. 2 shows a diagram of a first sheet adhesive single piece of Embodiment 3;

FIG. 3 shows a diagram of a second sheet adhesive single piece of Embodiment 3;

FIG. 4 shows a construction diagram of a two-component sheet adhesive of Embodiment 3;

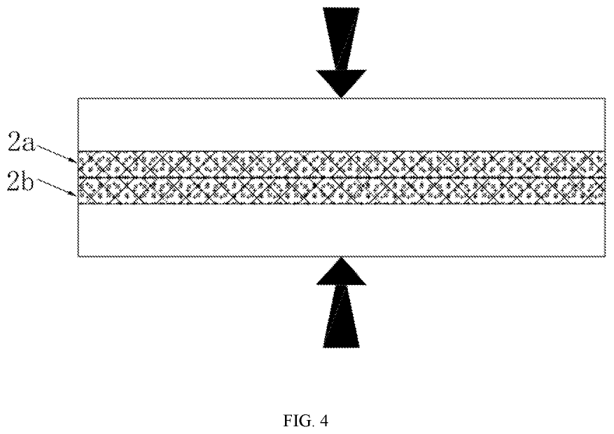

FIG. 5 shows a diagram of concave and convex structures of a first sheet adhesive single piece and a second sheet adhesive single piece of Embodiment 4.

### DETAILED DESCRIPTION OF THE EMBODIMENTS

In order to further explain respective embodiments, the present invention provides drawings. These drawings are a part of contents disclosed by the present invention, which are mainly used to explain the embodiments, and can interpret operation principles of the embodiments in conjunction with related depictions of the description. With reference to these contents, those ordinary skilled in the art should understand other possible embodiments and advantages of the present invention. The components in the drawings are not drawn in proportion, and similar component symbols are usually used to indicate similar components.

Now the present invention is further explained in conjunction with the drawings and specific embodiments.

### Embodiment 1

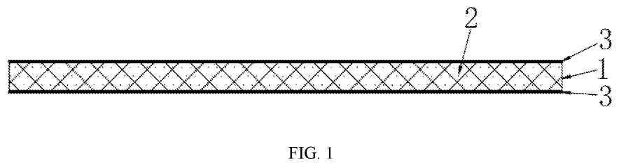

As shown in FIG. 1, the present invention provides a one-component sheet adhesive, including a sheet carrier 1, a colloid 2 and isolation films 3, the sheet carrier 1 having a plurality of non-closed accommodation spaces densely distributed therein, wherein the non-closed accommodation spaces may be pores or similar cavities formed in a single-layer mesh cloth, or regular or irregular shaped meshes or similar cavities in a three-dimensional mesh cloth, or pores or similar cavities in a multi-layer mesh cloth, or micropores or similar cavities in a polymer sheet skeleton having micropores, or pores or similar cavities in a fiber cloth interwoven by a natural fiber, a synthetic fiber or a mixed fiber; moreover, the materials of the sheet carrier are materials that do not react with the colloid and have good stability, such as non-textile cloths, textile cloths, fiber cloths, polymer sheet skeletons having micropores, or laminar web-like adhesive films and the like that meet the above defined requirements; the sheet carrier may also be constituted by a plurality of short fibers dispersed in the colloid to form having a carrier function, and the short fibers may be natural fibers, synthetic fibers or mixed fibers.

The colloid 2 is evenly coated on the sheet carrier 1. The coating method can be a coating method such as dipping or roller sizing. It should be clear that the colloid 2 itself has a certain viscosity and fluidity when it is not cured. After (the colloid 2) is coated on the sheet carrier 1, an effect similar to an adhesive tape is formed, so that it can be moved with the sheet carrier 1. A pore size of the pore on the sheet carrier 1 can be selected according to the viscosity and fluidity of the colloid adhesive solution. A shape of the pore can be square, diamond, and round or irregular.

The isolation films 3 seal and wrap the sheet carrier 1 coated with the colloid, so that the colloid 2 does not establish a contact with external curing conditions (including contacting air, humidity, light, etc.), to maintain its characteristics to be cured. Sealing and wrapping can be sealing and wrapping methods such as vacuum packaging or hot pressing, stamping and the like by using the insulation film. The isolation films are made by adopting materials that do not react with the colloid, do not adhere with the colloid, and have a good isolation effect.

The colloid 2 is a one-component curing adhesive. As shown in FIG. 1, the one-component curing adhesive can be a light curing adhesive, a water vapor curing adhesive, an air curing adhesive, a heat curing adhesive, or a pressure sensitive curing adhesive. When the colloid is the light curing adhesive, the isolation films should adopt light-blocking, black and brown isolation films that do not react with the colloid. When the colloid is the water vapor curing adhesive or the air curing adhesive, the isolation films should adopt a vacuum sealing and wrapping manner. When the colloid is the heat curing adhesive, it needs to perform heat insulation wrapping. When the colloid is the pressure sensitive curing adhesive, it needs to perform anti-pressure wrapping. When performing adhesion, the sheet adhesive with a corresponding shape and size is clipped according to a size of an adhesion interface, the isolation films are torn off, two objects that need to be adhered are compressed, and then the colloid is cured by using light, water vapor, air, heating or pressure, etc.

### Embodiment 2

With respect to Embodiment 1, Embodiment 2 of present invention also provides an adhesion method of the one-component sheet adhesive, which includes the following steps:

S1. providing the sheet adhesive of the above Embodiment 1;

S2. removing the isolation films of the sheet adhesive, and placing the same on a surface to be adhered; and

S3. providing a curing condition, so as to make the sheet adhesive be cured.

The above one-component film sheet adhesive can take the material according to the size of the adhesion interface to reduce waste of the adhesive material. In addition, the unused parts are still in a sealed and wrapped state and will not be cured, thereby facilitating a work required for long-term adhesive operations. There is also no need to perform actions such as stirring, and the generation of air bubbles is also avoided, especially at narrow adhesion interfaces, it can be convenient for sizing, thereby effectively avoiding the problem of incomplete adhesion.

### Embodiment 3

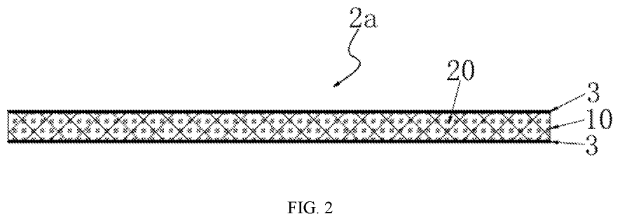

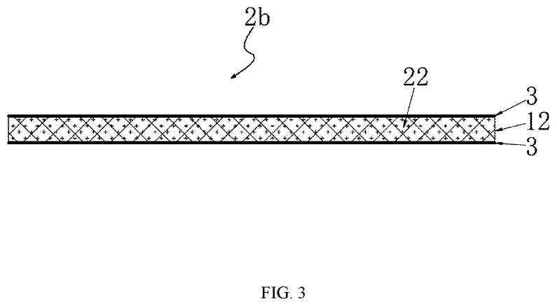

With reference to FIG. 2 and FIG. 3, FIG. 2 and FIG. 3 show a diagram of a two-component sheet adhesive, which includes a first sheet carrier 10, a second sheet carrier 12, a first colloid 20, a second colloid 22 and isolation films 3, wherein the first colloid and the second colloid are one of a raw adhesive and a curing agent, respectively, the sheet carrier 1 includes the first sheet carrier 10 and the second sheet carrier 12, and the first sheet carrier and the second sheet carrier both have a plurality of non-closed accommodation spaces densely distributed therein; wherein the non-closed accommodation spaces may be pores or similar cavities formed in a single-layer mesh cloth, or regular or irregular shaped meshes or similar cavities in a three-dimensional mesh cloth, or pores or similar cavities in a multi-layer mesh cloth, or micropores or similar cavities in a polymer sheet skeleton having micropores, or pores or similar cavities in a fiber cloth interwoven by a natural fiber, a synthetic fiber or a mixed fiber; moreover, the materials of the sheet carrier are materials that do not react with the colloid and have good stability, such as non-textile cloths, textile cloths, fiber cloths, polymer sheet skeletons having micropores, or laminar web-like adhesive films and the like that meet the above defined requirements; the sheet carrier may also be constituted by a plurality of short fibers dispersed in the colloid to form having a carrier function, and the short fibers may be natural fibers, synthetic fibers or mixed fibers.

The first colloid 20 is evenly coated on the first sheet carrier 10, and the isolation films 3 seal and wrap the first sheet carrier 10 coated with the first colloid 20, to constitute a first sheet adhesive single piece 2a. The second colloid 22 is evenly coated on the second sheet carrier 12, and the isolation films 3 seal and wrap the second sheet carrier 12 coated with the second colloid 22, to constitute a second sheet adhesive single piece 2b. The isolation films 3 seal and wrap the first sheet adhesive single piece 2a and the second sheet adhesive single piece 2b, respectively, that is, the first sheet adhesive single piece 2a and the second sheet adhesive single piece 2b form a two-component curing adhesive, wherein the two-component curing adhesive can be an epoxy resin adhesive, an acrylate resin adhesive, a polyurethane resin adhesive and the corresponding curing agent thereof, etc.

It should be clear that the first colloid 20 and the second colloid 22 themselves both have a certain viscosity and fluidity when they are not cured. After (the colloids) are coated on the first sheet carrier 10 and the second sheet carrier 12, an effect similar to adhesive tapes is formed, so that they can be moved with the first sheet carrier 10 and the second sheet carrier 12. Pore sizes of the pores on the first sheet carrier 10 and the second sheet carrier 12 can be selected according to the viscosity and fluidity of the colloid adhesive solution. A shape of the pore can be square, diamond, and round or irregular.

### Embodiment 4

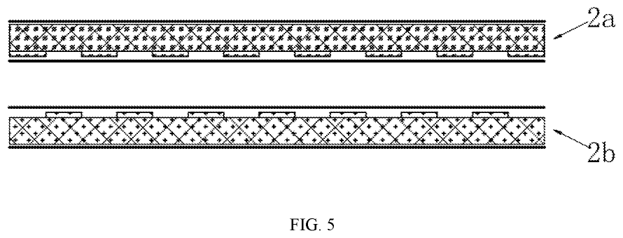

With reference to FIG. 5, wherein the embodiment is substantially the same as the above Embodiment 3, and a difference lies in improving: surfaces of the first sheet adhesive single piece 2a and the second sheet adhesive single piece 2b are formed with concave and convex structures that are matched with each other, respectively, so that the first sheet adhesive single piece 2a and the second sheet adhesive single piece 2b are aligned and fitted better, and the first colloid and the second colloid can also be permeated and mixed with each other better after the two pieces are fitted and the pressure is applied.

### Embodiment 5

With respect to the above Embodiment 3 or 4, Embodiment 5 of present invention also provides an adhesion method of the two-component sheet adhesive, which includes the following steps:

S1. providing the sheet adhesive of the above Embodiment 3 or 4, which includes the first sheet adhesive single piece and the second sheet adhesive single piece;

S2. removing the isolation films of the first sheet adhesive single piece and the second sheet adhesive single piece, respectively, and placing the same on a surface to be adhered, respectively; and

S3. applying pressures to the first sheet adhesive single piece and the second sheet adhesive single piece to make the first colloid and the second colloid of the first sheet carrier and the second sheet carrier be permeated and mixed with each other, so as to make the sheet adhesive be cured.

The above two-component curing sheet adhesive tape can take the material according to the size of the adhesion interface to reduce waste of the adhesive material, thereby facilitating a work required for long-term adhesive operations. Moreover, there is also no need to perform actions such as stirring, and the generation of air bubbles is also avoided, especially at narrow adhesion interfaces, it can be convenient for sizing, thereby effectively avoiding the problem of incomplete adhesion. The two-component curing sheet adhesive tapes are fully fitted according to a proportion of the adhesion interfaces. After the lamination, the raw adhesive and the curing agent are mixed uniformly, which can effectively ensure that the raw adhesive is fully cured and ensure the adhesion effect.

Although the present invention is specifically shown and introduced in conjunction with the preferred embodiments, those skilled in the art should understand that various changes can be made on the present invention in form and detail without departing from the spirit and scope of the present invention as defined by the appended claims, and the changes are all made within the protection scope of the present invention.

What is claimed is:

1. A sheet-shaped adhesive, characterized in: comprising a sheet carrier, a colloid, and isolation films, wherein the sheet carrier has a plurality of non-closed accommodation spaces densely distributed therein, the colloid is coated on the sheet carrier, permeates and fills all the accommodation spaces, and the isolation films seal and wrap the sheet carrier coated with the colloid.

2. The sheet-shaped adhesive of claim 1, characterized in: the colloid is a one-component curing adhesive, and the one-component curing adhesive comprises a light curing adhesive, a water vapor curing adhesive, an air curing adhesive, a heat curing adhesive, or a pressure sensitive curing adhesive.

3. The sheet-shaped adhesive of claim 1, characterized in: the sheet carrier comprises a single-layer mesh cloth, a three-dimensional mesh cloth, a polymer sheet skeleton having micropores, a natural fiber textile sheet or a synthetic fiber textile sheet or a mixed fiber textile sheet constituted by fibers being interwoven with each other, or is constituted by several short fibers dispersed in the colloid to form having a carrier function.

4. A sheet-shaped adhesive, characterized in: comprising a first sheet carrier, a second sheet carrier, a first colloid, a second colloid and isolation films, wherein the first sheet carrier and the second sheet carrier both have a plurality of non-closed accommodation spaces densely distributed therein; the first colloid is coated on the first sheet carrier, permeates and fills all the accommodation spaces, to constitute a first sheet adhesive single piece; the second colloid is coated on the second sheet carrier, permeates and fills all the accommodation spaces, to constitute a second sheet adhesive single piece; the isolation films seal and wrap the first sheet adhesive single piece and the second sheet adhesive single piece, respectively; the first colloid and the second colloid are one of a raw adhesive and a curing agent, respectively; and the first sheet adhesive single piece and the second sheet adhesive single piece form a two-component curing adhesive.

5. The sheet-shaped adhesive of claim 4, characterized in: the first sheet carrier and the second sheet carrier comprise a single-layer mesh cloth, a three-dimensional mesh cloth, a polymer sheet skeleton having micropores and a natural fiber textile sheet or a synthetic fiber textile sheet or a mixed fiber textile sheet constituted by fibers being interwoven with each other, or are constituted by several short fibers dispersed in the colloid to form having a carrier function.

6. The sheet-shaped adhesive of claim 4, characterized in: surfaces of the first sheet adhesive single piece and the second sheet adhesive single piece are formed with concave and convex structures that are matched with each other, respectively.

7. An adhesion method, characterized in comprising the following steps:
S1. providing the sheet-shaped adhesive of the above claim 1;
S2. removing the isolation films of the sheet-shaped adhesive, and placing the same on a surface to be adhered; and
S3. providing a curing condition, so as to make the sheet-shaped adhesive be cured.

8. An adhesion method, characterized in comprising the following steps:
S1. providing the sheet-shaped adhesive of the above claim 4, which comprises a first sheet adhesive single piece and a second sheet adhesive single piece;
S2. removing the isolation films of the first sheet adhesive single piece and the second sheet adhesive single piece, respectively, and placing the same on a surface to be adhered, respectively; and
S3. applying pressures to the first sheet adhesive single piece and the second sheet adhesive single piece to make the first colloid and the second colloid of the first sheet carrier and the second sheet carrier be permeated and mixed with each other, so as to make the sheet-shaped adhesive be cured.
